(19) United States
(12) Patent Application Publication
(10) Pub. No.: US 2025/0328031 A1
(43) Pub. Date: Oct. 23, 2025

(54) COMPACT VISUAL AID DEVICE UTILIZING THE PINHOLE EFFECT

(71) Applicants: Karen M. Cruz, San Diego, CA (US); Brianna C. Valenzuela, San Diego, CA (US); Melinda S. Kamariotis, Santa Rosa, CA (US); Kimberly A. Cruz, Lemon Grove, CA (US)

(72) Inventors: Karen M. Cruz, San Diego, CA (US); Brianna C. Valenzuela, San Diego, CA (US); Melinda S. Kamariotis, Santa Rosa, CA (US); Kimberly A. Cruz, Lemon Grove, CA (US)

(21) Appl. No.: 19/255,940

(22) Filed: Jun. 30, 2025

Related U.S. Application Data
(60) Provisional application No. 63/666,544, filed on Jul. 1, 2024.

(51) Int. Cl. G02C 7/16; G02C 5/00

(52) U.S. Cl. CPC G02C 7/16; G02C 5/001

(57) ABSTRACT

A portable visual aid device for enhancing visual clarity using the pinhole effect. The device comprises a flat, card-sized substrate containing at least one pinhole aperture configured to restrict peripheral light and permit focused, central light to enter the eye, thereby improving visual sharpness. The substrate may be formed from plastic, metal, paper-based material, or composites, and may include variations such as multiple apertures, foldable panels, or detachable segments for individual use. Designed to be carried in a wallet or purse, the device enables situational vision support for tasks such as reading small text in low-light environments, reviewing printed documents, or participating in basic vision screenings. The device requires no prescription, lenses, or power source, offering an accessible, low-cost solution for temporary or emergency visual assistance.

This application claims the benefit of U.S. Provisional Patent Application No. 63/666,544, filed Jul. 1, 2024, the entire content of which is incorporated herein by reference.

### NOMENCLATURE

For purposes of clarity and readability, the visual aid device described in this application is referred to throughout as QuickEye™. QuickEye is a trademark of QuickEye LLC, and registration of the mark is currently pending. The use of the trademark herein is for descriptive purposes only and shall not be construed as limiting the scope of the claimed invention.

### BACKGROUND

Many individuals experience difficulty reading fine print or focusing on distant objects due to a variety of factors, including natural differences in eyesight, aging, fatigue, and environmental conditions such as low lighting. While prescription glasses are the standard solution, they are not always the most practical option for spontaneous or short-term visual challenges. Additionally, healthcare access and the rising cost of vision correction present challenges for individuals who lack insurance or resources.

The pinhole optical principle has been shown to improve visual acuity by allowing only focused light rays to enter the eye, thereby minimizing the effects of refractive errors and sharpening the perceived image. Although pinhole glasses and similar tools exist, they are often bulky, conspicuous, or impractical for everyday use. There remains a need for a compact, non-powered, low-cost device that can provide quick, on-demand visual support for individuals with poor eyesight, whether permanent or situational.

The present invention addresses this need.

### SUMMARY

The present disclosure describes a portable visual aid, referred to herein as QuickEye, that utilizes the pinhole effect to enhance visual clarity for both near and distant tasks. The device operates using the pinhole optical principle, which restricts peripheral light and allows only centrally aligned rays to enter the eye. This reduces visual distortion caused by refractive errors and sharpens the perceived image without the need for corrective lenses.

QuickEye is manufactured in a compact, flat, card-like format that can easily be carried in a wallet, purse, or pocket. The device may be constructed from a variety of materials, including but not limited to plastic, metal (such as aluminum), rigid paper products, composites, or any structurally stable medium capable of supporting one or more pinhole apertures. Material choice may vary based on intended use, durability requirements, aesthetic considerations, or manufacturing preferences.

Although the card-like format offers convenience and portability, QuickEye may also be configured in alternate forms to suit user preferences or commercial applications. In certain implementations, the device may include foldable panels with perforated edges, allowing individual segments containing pinhole apertures to be detached and shared. This configuration supports versatility in use and distribution, particularly in educational, promotional, or healthcare screening settings.

QuickEye operates without external power or corrective lenses, offering a lightweight, accessible solution for temporary visual enhancement.

### BRIEF DESCRIPTION OF THE DRAWINGS

FIG. 1 is a front view of the QuickEye visual aid device in its compact, card-like format, showing overall dimensions and the location of one or more pinhole apertures.

FIG. 2 is a rear view of the device shown in FIG. 1, optionally illustrating structural materials, alignment guides, or surface treatments.

FIG. 3 is a front view of an alternate embodiment of the QuickEye device, illustrating a different pinhole aperture layout or surface configuration.

FIG. 4 is a front view of another alternate embodiment of the QuickEye device, featuring a foldable panel structure with one or more perforated segments, each containing a pinhole aperture for individual use or distribution.

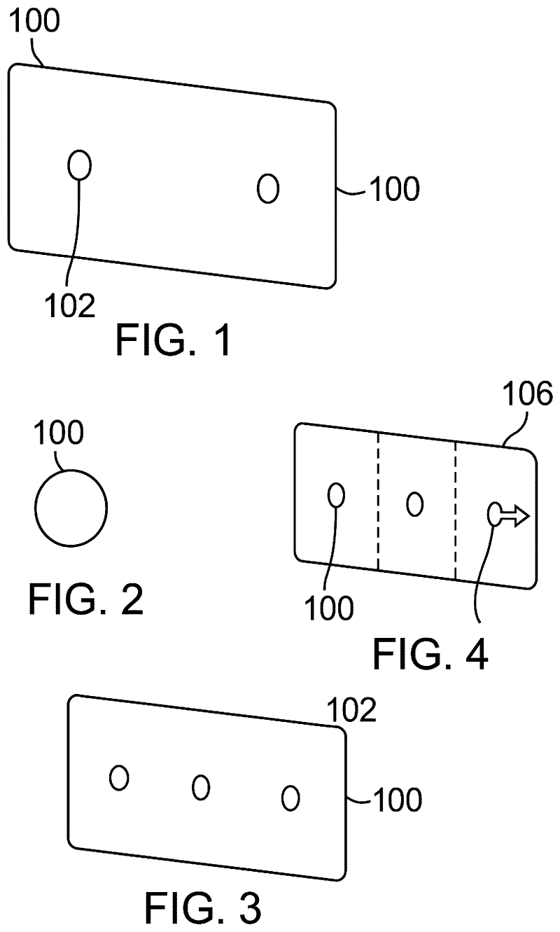

### DETAILED DESCRIPTION

### Optical Principle

The QuickEye device operates based on the pinhole optical principle, which improves visual clarity by physically restricting the entry of peripheral light rays into the eye. When light passes through a small aperture, only the most direct, centrally aligned rays reach the retina, thereby reducing the effects of refractive errors and sharpening the perceived image. This optical behavior is well-documented in clinical and educational settings and forms the scientific foundation for the device's utility in temporary or situational vision enhancement.

### Materials and Construction

The visual aid device may be fabricated from a rigid or semi-rigid substrate that maintains structural stability while being thin and portable. Acceptable materials include polymeric plastic (e.g., polystyrene, polyethylene), lightweight metal (e.g., aluminum alloy), compressed fiberboard or paperboard, and multi-layered composite materials. Surface treatment may be applied to improve visual contrast, durability, or texture, including matte coatings, UV-resistant laminates, or embossed guides.

The pinhole aperture may be formed during manufacturing via die-cutting, laser perforation, drilling, or precision molding. In one embodiment, the aperture diameter ranges between 1.1 mm and 2.0 mm, depending on the intended user population. Multiple apertures may be formed in parallel or staggered locations to accommodate users with different eye alignment needs.

### User Operation

To use the device, the user positions the card or panel in front of one eye such that their line of sight passes directly through the pinhole aperture. The opposite eye may be closed or covered for optimal focus. The user then directs their gaze toward the object of interest, such as a line of text or distant signage. Because the pinhole filters out scattered light rays, the image perceived by the user may appear sharper and easier to distinguish, particularly in conditions of low contrast or dim lighting.

### Design Variants

In alternate configurations, the device may include a folding or bifurcated panel structure allowing the unit to compress for storage or expand for alignment. Detachable segments with individual apertures may be incorporated for hygienic sharing, bulk distribution, or single-use applications such as vision screenings in educational or clinical environments. Printed guides or contrast rings around the aperture may assist users with visually locating and aligning the pinhole.

Other configurations may include a transparent or translucent body with embedded apertures, enabling ambient light transmission while preserving optical focus through the central hole. Devices may be circular, rectangular, triangular, or custom-contoured without departing from the scope of the disclosure.

### USE CASE EXAMPLES

One common scenario involves individuals attempting to read restaurant menus, receipts, or product expiration dates in dim lighting. In such cases, QuickEye offers a discreet and immediate visual aid, enhancing clarity without the need for prescription glasses or external lighting devices.

Another use case pertains to reviewing printed documents, forms, or signage when standard reading aids are unavailable-such as while traveling, during emergencies, or in outdoor settings. QuickEye's compact format ensures it can be kept on hand for such moments, stowed easily in a wallet or pocket.

The device also proves valuable in resource-limited environments, such as vision screening events, health clinics, or educational demonstrations where multiple users can benefit from temporary pinhole-based vision enhancement. The detachable panel format allows for individual use while maintaining hygienic distribution and cost-efficiency.

What is claimed is:

1. A visual aid device comprising:
a flat substrate;
at least one pinhole aperture formed through the substrate and configured to enhance visual clarity by permitting centrally aligned light rays to pass through while restricting peripheral light;
wherein the device is sized to be carried in a wallet or purse and requires no prescription lens or external power source to operate.

2. The device of claim 1, wherein the substrate is made of a rigid material selected from the group consisting of plastic, aluminum, paperboard, or composite materials.

3. The device of claim 1, wherein the at least one pinhole aperture has a diameter between 1.1 mm and 2.0 mm.

4. The device of claim 1, further comprising printed visual guides to assist with alignment between the user's eye and the aperture.

5. The device of claim 1, wherein the substrate includes a plurality of pinhole apertures arranged in a pattern to accommodate different user needs.

6. The device of claim 1, wherein the substrate includes foldable panels with perforated edges, allowing for selective detachment of segments each containing a pinhole aperture.

7. A method of improving visual clarity, the method comprising:
providing a device comprising a flat substrate with at least one pinhole aperture;
positioning the device such that the user's line of sight is aligned with the pinhole aperture;
restricting peripheral light rays while allowing central light rays to pass through the pinhole aperture to the user's eye, thereby enhancing image sharpness.

8. The method of claim 7, further comprising selecting a detachable segment from a foldable substrate structure for individual or temporary use.

9. The method of claim 7, wherein the device is constructed from a portable and non-powered substrate for on-demand situational use.

10. The method of claim 7, further comprising using the device in a low-light, glare-prone, or outdoor environment to enhance legibility of small print.
